(19) United States
(12) Patent Application Publication
(10) Pub. No.: US 2026/0204922 A1
(43) Pub. Date: Jul. 16, 2026

(54) INVERTER CONTROL USING A VIRTUAL FOURTH PHASE AND AN EMULATED SOURCE IMPEDANCE FOR SHORT CIRCUIT RECOVERY IN MICROGRIDS

(71) Applicant: Bloom Energy Corporation, San Jose, CA (US)

(72) Inventors: Chaitanya Mandela, Bangalore (IN); Ranganathan Gurunathan, Bengaluru (IN); Vishal Anand Aisur Gopalakrishnan, Bangalore (IN); Saravanakumar Narayanasamy, Bengaluru (IN); Ayyappa Rudrasimha Yedida, Bengaluru (IN); Ponkiran Ponnappan, Bangalore (IN)

(73) Assignee: Bloom Energy Corporation, San Jose, CA (US)

(21) Appl. No.: 19/365,801

(22) Filed: Oct. 22, 2025

(30) Foreign Application Priority Data
Jan. 10, 2025 (IN) 202511002568

(51) Int. Cl. H02J 3/44; H02J 3/00; H02J 3/24

(52) U.S. Cl. CPC H02J 3/44; H02J 3/001; H02J 3/00142; H02J 2103/35

(57) ABSTRACT

Provided is a sync inverter that is controlled to synchronize to a grid voltage and generate a fourth phase (virtual fourth phase). The voltage and frequency of the sync inverter are generated by a droop controller. The sync inverter uses a virtual power measurement for droop control by simulating an impedance at its output. The sync inverter may be communicatively coupled to grid inverters. The grid inverters may estimate an active power and a reactive power by simulating an impedance between their respective outputs to the fourth phase voltage. The droop controllers of individual inverters of a microgrid may use the estimated power values for determining the voltage and frequency generated by their droop controllers. Incorporating the estimated power export to the fourth phase voltage aids in syncing the grid inverters to the voltage generated by the sync inverter and riding through bolted short circuits and overload conditions for safe recovery.

### BACKGROUND

### Technical Field

This application is directed to controlling an inverter for short circuit recovery in microgrids and, in particular, using a virtual fourth phase and an emulated source impedance to control the inverter.

### Description of the Related Art

Droop control is used in managing and controlling inverters connected to a microgrid. However, the use of droop control is associated with increased risks of loss of synchronization between the inverters and the microgrid during sustained short circuit conditions. Droop control achieves synchronization between grid power sources by providing a negative feedback based on the circulating power between the sources and the microgrid. However, during bolted or low impedance short circuits, negative feedback is no longer provided by the droop control.

### BRIEF SUMMARY

Provided are techniques for controlling an inverter that feeds power into the grid using droop control. A controller receives a measurement of the voltage of a DC bus of the inverter. The DC bus voltage reflects whether the inverter is operating outside a rating of the inverter. For example, when the DC bus voltage is greater than an overvoltage threshold, it may be determined that the inverter imports more power from the grid than a rating of the inverter allows. When the DC bus voltage is less than an undervoltage threshold, it may be determined that the inverter exports more power to the grid than the rating allows.

If the controller determines that the DC bus voltage is greater than the overvoltage threshold or less than the undervoltage threshold, the controller disables droop control. The controller uses a phase lock loop (PLL) to determine the frequency and/or phase of the grid voltage. During the time that the PLL takes to lock to the frequency and/or phase of the grid voltage, the controller limits the output current of the inverter to be within the rating of the inverter.

After the PLL locks to the frequency and/or phase of the grid voltage, the controller sets a reference voltage of the inverter to a voltage level of the grid output by the PLL and sets a reference frequency of the inverter to a frequency of the grid output by the PLL stage and thereby limits the power export to the grid to a threshold value. The controller enables droop control after the controller determines that the DC bus voltage is less than the overvoltage threshold and greater than the undervoltage threshold.

Provided is a sync inverter. The sync inverter is controlled to synchronize to the grid voltage and generate a fourth phase (or a virtual fourth phase). The voltage and frequency of the sync inverter are generated by a droop controller. The sync inverter uses a virtual power measurement for a droop controller by simulating an impedance at its output. The sync inverter may be communicatively coupled to inverters of the grid. The inverters of the grid may estimate an active power and a reactive power by simulating an impedance between their respective outputs to the fourth phase voltage generated by the sync inverter. The droop controllers of individual inverters of a microgrid may use the estimated power values for determining the voltage and frequency generated by their droop controllers. Incorporating the estimated power export to the fourth phase voltage generated by sync inverter aids in syncing the inverters of the microgrid to the voltage generated by sync inverter. The voltage generated by sync inverter may be used to ride through bolted short circuits and overload conditions for safe recovery.

### BRIEF DESCRIPTION OF THE SEVERAL VIEWS OF THE DRAWINGS

FIG. 1 shows a controller for an inverter.

FIG. 2 shows an RL circuit model of current between two nodes.

FIG. 3 shows a controller for an inverter with a multiplier.

FIG. 4 shows a voltage source connected to a grid.

FIG. 5 shows a droop control system for an inverter.

FIG. 6 shows a droop control method.

FIG. 7 shows a sync inverter and a plurality of grid inverters coupled to the grid.

FIG. 8 shows a droop controller of the sync inverter.

FIG. 9 shows a grid inverter coupled to the grid.

FIG. 10 shows a sync inverter coupled to the grid.

### DETAILED DESCRIPTION

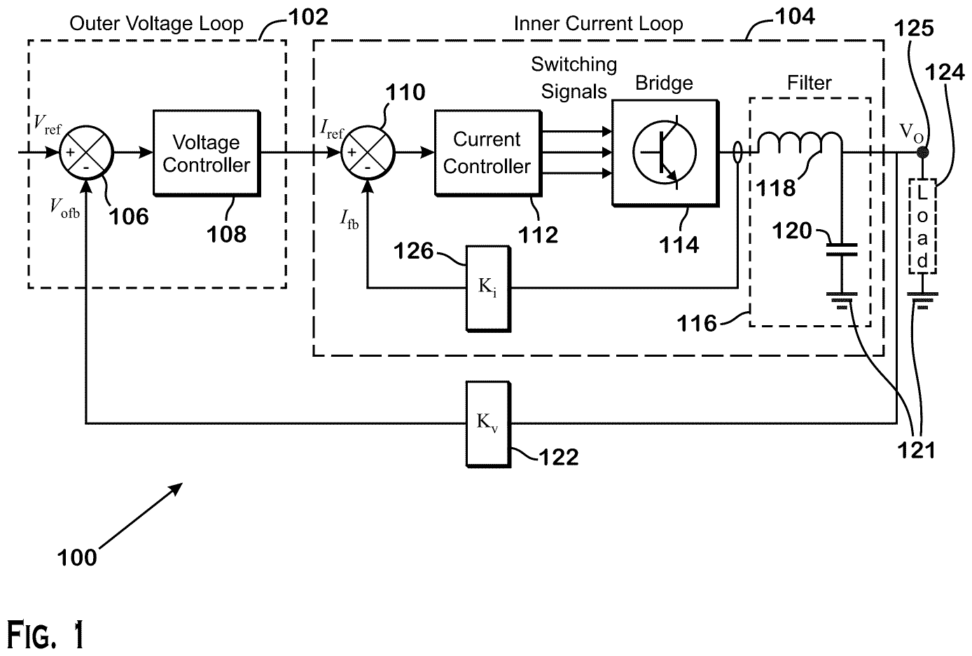

FIG. 1 shows a controller 100 for an inverter in accordance with an embodiment.

The inverter controller 100 includes an outer voltage loop 102 and an inner current loop 104. The outer voltage loop 102 includes a subtractor 106 and a voltage controller 108. The inner current loop 104 includes a subtractor 110, a current controller 112 and a bridge 114, which may be a three-phase bridge. The inner current loop 104 also includes a filter 116. The filter 116 includes an inductance 118 and a capacitance 120.

The subtractors 106, 110 each have first and second inputs and an output. The voltage controller 108 has an input coupled to the output of the first subtractor 106 and an output. The current controller 112 has an input indirectly coupled to the output of the voltage controller 108 and three outputs. The bridge 114 has three control inputs that are respectively coupled to the outputs of the current controller 112 and a power output. The inductance 118 has first and second terminals. The first terminal is coupled to the power output of the bridge 114. The capacitance 120 has first and second sides. The first side is coupled to the second terminal of the inductance 118, and the second side is coupled to a reference voltage node 121, which may be a ground node.

The subtractor 106 receives a reference voltage (V_{ref}) for an output voltage (Vₒ) of the inverter. The reference voltage (V_{ref}) may be a desired (or sought) value for the output voltage (Vₒ). The subtractor 106 receives the reference voltage (V_{ref}) over its first input and a feedback voltage (V_{ofb}) representative of the output voltage (Vₒ) over its second input. The subtractor 106 determines the difference (or error) between the reference voltage (V_{ref}) and the feedback voltage (V_{ofb}) and outputs the difference over its output. The output voltage (Vₒ) is measured across the capacitance 120 and fed back to the outer voltage loop 102. A voltage gain multiplier 122 models a voltage multiplier (Kᵥ) with which the output voltage (Vₒ) is multiplied to produce the feedback voltage (V_{ofb}). The voltage multiplier (Kᵥ) may be any number, such as 0.5, 1 or 1.5, among others. The voltage gain multiplier 122 models voltage division and channel and processing effects that act on the measured output voltage (Vₒ) to produce the feedback voltage (V_{ofb}). It is noted that although a multiplier is described herein, a divider that performs voltage division may be used instead.

The voltage controller 108 receives the difference from the subtractor 106 as an input. The voltage controller 108 determines a current reference (I_{ref}) from the difference between the reference voltage (V_{ref}) and the feedback voltage (V_{ofb}). The subtractor 110 receives the current reference (I_{ref}) over its first input and receives a feedback current (I_{fb}) representative of the output current over its second input. The subtractor 110 determines the difference (or error) between the feedback current (I_{fb}) and the current reference (I_{ref}) and outputs the difference over its output. The output current is measured at the inverter output to a load 124. The load 124 is shown as being coupled between an output node 125 and the reference voltage node 121.

The output current is fed back to the inner current loop 104. A current gain multiplier 126 models a current multiplier (Kᵢ) with which the output current is multiplied to produce the feedback current (I_{fb}). The current multiplier (Kᵢ) may be any number, such as 0.5, 1 or 1.5, among others. The current gain multiplier 126 models channel and processing effects that act on the measured output current to produce the feedback current (I_{fb}). The output current may be measured by a current sensor such as current transformer (CT), hall effect current sensor, among others, coupled to an output of the inverter, and the output voltage may be measured by a voltage sensor such as potential transformer (PT), a differential voltage sensor, or an instrumentation amplifier, among others, coupled across the capacitance 120. It is noted that although a multiplier is described herein, a divider that performs current division may be used instead.

The current controller 112 receives the difference between the currents over its input. The current controller 112 generates switching signals for operating the bridge 114 based on the difference between the currents. The bridge 114 includes switches, which may be insulated-gate bipolar transistors (IGBTs), metal-oxide-semiconductor field-effect transistors (MOSFETs) or a combination thereof. The bridge 114 receives the switching signals over its inputs and operates the switches thereof in accordance with the switching signals. As result of the switching operations, the bridge 114 outputs voltage and current to the filter 116 that reduce the difference between the reference and output currents. The filter 116 outputs, over the output node 125, the output voltage (Vₒ) to the load 124. The output voltage (Vₒ) is associated with the output current that is also output to the load 124.

The voltage controller 108 may be a proportional integral (PI) controller. As described herein, a controller may have one or more of a proportional, integral and derivative components. A proportional component is a proportional term used to produce an output that is proportional to an error (or difference) between reference and measured values received at an input of the controller. An integral component is an integral term that accumulates past errors over time. The integral term integrates the error and outputs an integral of the error. A derivative component is a derivative term that predicts a future error based on a rate of change of the input. A PID controller may aggregate all three terms, whereas a PI controller may aggregate the proportional and integral terms. It is noted that the voltage controller may be implemented digitally or in an analog domain (e.g., using an operational amplifier circuit).

The current reference (I_{ref}) may be represented in the Laplace domain as:

$${l}_{ref} ( s ) = \frac{s * {K}_{p} + {K}_{i}}{s} * ( {V}_{ref} ( s ) - {V}_{ofb} ( s ) ) . \qquad Equation ( 1 )$$

In Equation (1), s is the Laplace operator, Kₚ is the proportional gain of the voltage controller 108, Kᵢ is the integral gain of the voltage controller 108, V_{ref}(s) is the representation of the reference voltage (V_{ref}) in the Laplace domain and V_{ofb}(s) is the representation of the feedback voltage (V_{ofb}) in the Laplace domain.

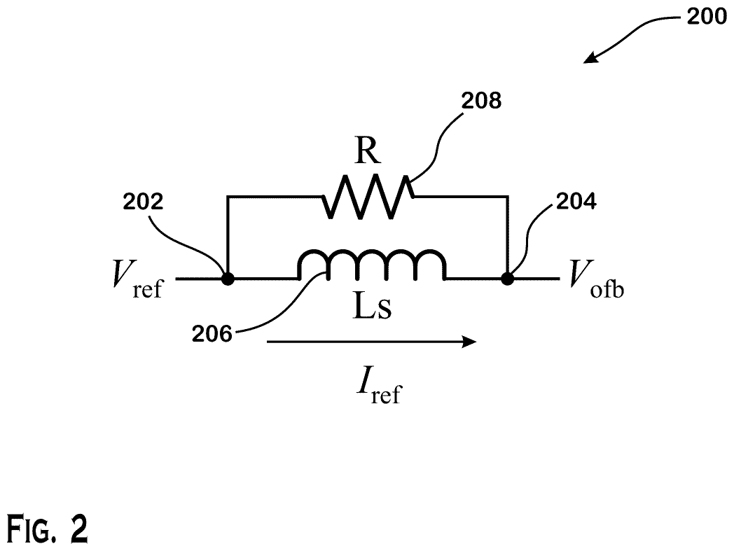

FIG. 2 shows a parallel RL circuit model 200 of current between two nodes 202, 204. In the model 200, an inductance 206 and a resistance 208 are coupled to each other in parallel. The two components are together coupled between a first node 202 and a second node 204. The model 200 assigns the first node 202 a voltage that is the same as the reference voltage (V_{ref}) and assigns the second node 204 a voltage that is the same as the feedback voltage (V_{ofb}). The model 200 assigns the current flowing from the first node 202 to the second node 204 to be equal to the current reference (I_{ref}). Thus, the model 200 assumes that the inverter acts as the inductance 206 and the resistance 208 connected in parallel. Per the model 200, the current reference (I_{ref}) may be represented in the Laplace domain as:

$$\begin{matrix}{I}_{ref} ( s ) = ( \frac{1}{R} + \frac{1}{Ls} ) * ( {V}_{ref} ( s ) - {V}_{0 fb} ( s ) ) \\ = \frac{s * \frac{1}{R} + \frac{1}{L}}{s} * ( {V}_{ref} ( s ) - {V}_{0 fb} ( s ) ) .\end{matrix} \qquad Equation ( 2 )$$

Equating Equations (1) and (2) yields the proportional gain (Kₚ) of the voltage controller 108 as:

$${K}_{p} = \frac{1}{R} . \qquad Equation ( 3 )$$

The equating yields the integral gain (Kᵢ) of the voltage controller 108 as:

$${K}_{i} = \frac{1}{L} . \qquad Equation ( 4 )$$

Thus, the voltage controller 108 of FIG. 1 may emulate a source impedance by selecting the proportional gain (Kₚ) to be a reciprocal of the desired source resistance and selecting the integral gain (Kᵢ) to be a reciprocal of the desired source inductance. The emulated impedance may be predominantly inductive. The impedance values may be scaled (or per unit) values calculated at a PI controller level (typically at a signal level corresponding to the voltage (Kᵥ) and current (Kᵢ) sensor gains or ratios). The impedance values may be scaled according to an inverter power level.

It is noted that a scaled version of the reference voltage (V_{ref}) of the voltage controller 108 which may be

$$( \frac{{V}_{ref}}{{K}_{v}} )$$

appears as the no load voltage of the inverter. The output voltage drops with use of a load due to a steady state error caused by the limited gain of voltage controller at an operating fundamental frequency. The output voltage drop manifests as a voltage drop across the source impedance. The impedance emulated by the voltage controller controls power flow between the inverter and any other voltage source depending on the phase shift and the voltage difference between the sources. The emulation of impedance through the voltage controller reduces (or altogether eliminates) the use of a physical impedance, thereby resulting in cost and space savings.

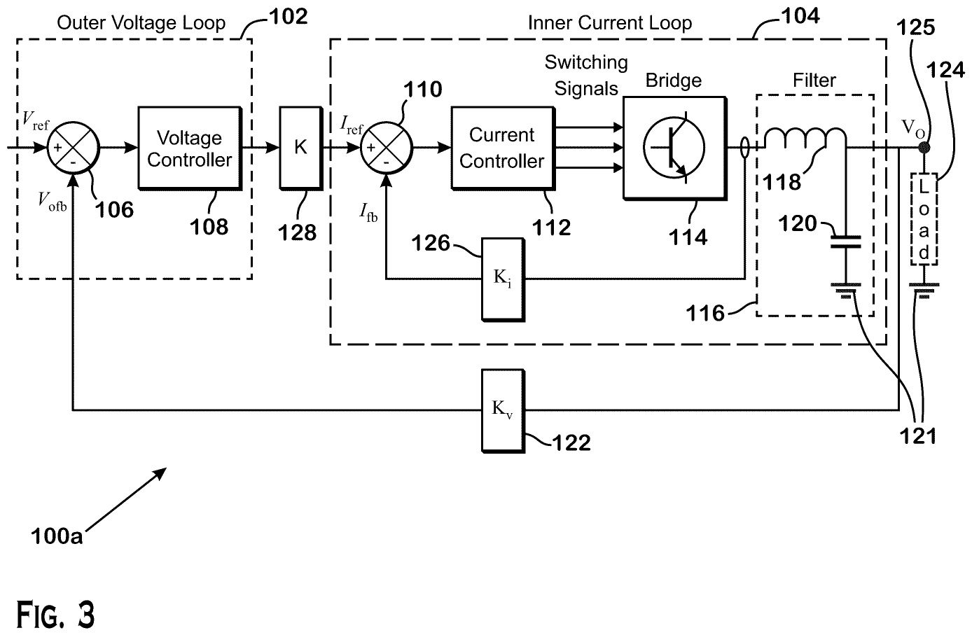

FIG. 3 shows a controller 100a for an inverter in accordance with an embodiment. Similar elements of the inverter controller 100a as those of the inverter controller 100 have the same reference numerals. The inverter controller 100a additionally includes an impedance multiplier 128 disposed between the voltage controller 108 and the subtractor 110. The impedance multiplier 128 has an input coupled to the output of the voltage controller 108 and an output coupled to the first input of the subtractor 110.

The impedance multiplier 128 dynamically controls a magnitude of the impedance without changing its phasor. The impedance multiplier 128 multiplies the impedance by a multiplication factor (K), which may be between 0 and 1. The multiplication factor (K) may proportionally reduce the gains (Kₚ, Kᵢ) and increase the emulated impedance by the same factor. The emulated impedance may be Z/K, where Z is the emulated impedance without use of the multiplication factor.

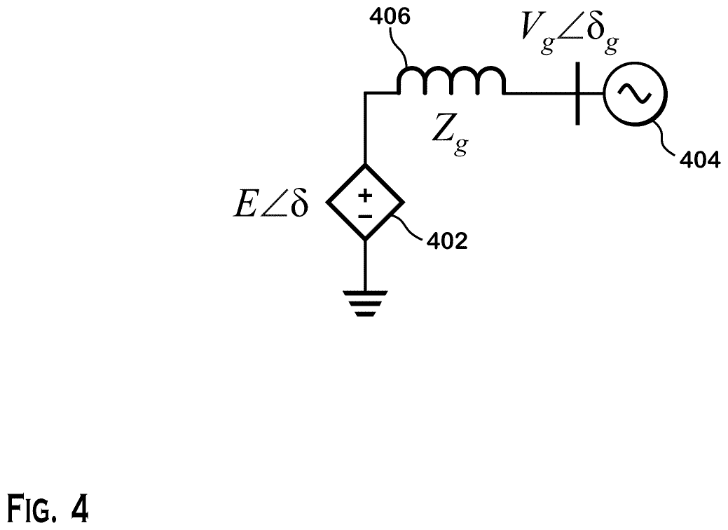

FIG. 4 shows a voltage source, such as an inverter 402, connected to a grid 404. The grid 404 may include a microgrid. An impedance (Z_{g}) 406 is shown between the inverter 402 and the grid 404. The grid 404 has a grid voltage (V_{g}) that is associated with a phase (δ_{g}). The inverter 402 terminal voltage is represented by the voltage magnitude (E) associated with the phase angle (δ). The apparent power(S) exported by the inverter 402 is \sqrt{P²+Q²}, where P is an active power component of the apparent power(S) and Q is a reactive power component of the apparent power(S). The sum of squares of the active and reactive power components is:

$${P}^{2} + {Q}^{2} = {( \frac{E * {V}_{g} sin ( δ - {δ}_{g} ) )}{{Z}_{g}} )}^{2} + {( \frac{{V}_{g} * ( E cos ( δ - {δ}_{g} ) - {V}_{g} )}{{Z}_{g}} )}^{2} . \qquad Equation ( 5 )$$

When the difference between the phases of the inverter and the grid is relatively small, the cosine of the difference in phases approximates to one and the sine of the difference approximates to zero (e.g., cos (δ-δ_{g})~1 and sin (δ-δ_{g})~0 for small values of (δ-δ_{g})). Further, the impedance (Z_{g}) may be modeled as being inductive (X_{g}) rather than resistive. Under the above assumptions, Equation (5) may be recast as:

$${P}^{2} + {Q}^{2} = 0 + {( \frac{{V}_{g} * ( E - {V}_{g} )}{{Z}_{g}} )}^{2} = {( \frac{E * {V}_{g}}{{X}_{g}} )}^{2} * {( 1 - \frac{{V}_{g}}{E} )}^{2} . \qquad Equation ( 6 )$$

The exported apparent power(S) is derived from Equation (6) as:

$$S = ( \frac{E * {V}_{g}}{{X}_{g}} ) * ( 1 - \frac{{V}_{g}}{E} ) . \qquad Equation ( 7 )$$

Equation (7) illustrates that the exported apparent power(S) is inversely proportional to the inductive impedance (X_{g}). That is,

$$S ∝ \frac{1}{{X}_{g}} .$$

The current exported by the inverter 402 follows the apparent power(S) and is also inversely proportional to the impedance

$$( i . e . , {I}_{inv} ∝ \frac{1}{{X}_{g}} ) .$$

Further, as explained herein, the inductive impedance (X_{g}) is also inversely proportional to the multiplication factor (K)

$$( i . e . , {X}_{g} ∝ \frac{1}{K} ) .$$

Because the current exported by the inverter 402 is inversely proportional to the impedance and the impedance is inversely proportional to the multiplication factor (K), it follows that the current output by the inverter 402 is proportional to the multiplication factor (K) (i.e., Iᵢₙᵥ ∝K) and hence can be directly controlled by the multiplication factor (K).

The multiplication factor (K) directly controls the exported power and the output current of the inverter. Controlling the output current during overload conditions limits the inverter current from reaching saturation limits and maintains a linear relation between the source voltage and output current throughout operation during short circuit and overload conditions.

Short circuit and overload conditions in the grid 404 cause phase and frequency shifts between parallel sources connected to the grid 404. Sustained short circuits (which may be short circuits having a duration greater than two seconds) may result in significant phase shifts between the connected sources. For example, a phase shift between two connected sources may reach +/−180° during a sustained short circuit. The phase shift causes significant power circulation and results in a grid failure.

Droop control is a technique that is used to synchronize different sources connected in a grid. However, conventional droop control is not effective to recover the short circuit and overload conditions when the phase shifts between the sources of the grid are large.

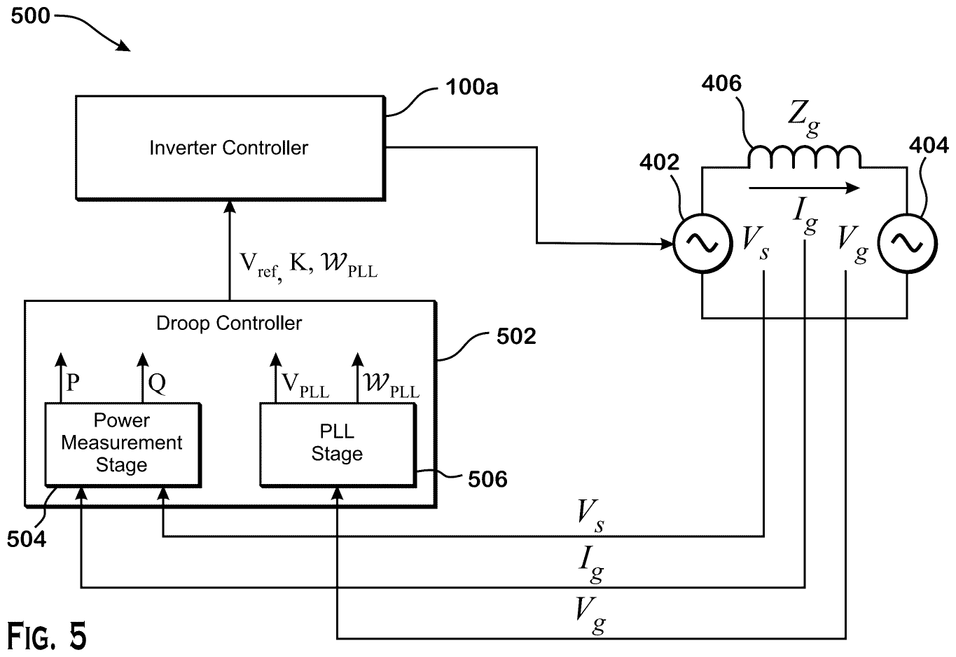

FIG. 5 shows a droop control system 500 for the inverter 402. The droop control system 500 includes a droop controller 502 and the inverter controller 100a. The inverter controller 100a controls the inverter 402, which is connected to the grid 404 as described with reference to FIG. 4. The droop controller 502 includes a power measurement stage 504 and a phase lock loop (PLL) stage 506. The power measurement stage 504 receives, over a first input, a measurement of a voltage (Vₛ) output by the inverter 402 and receives, over a second input, a measurement of a current (I_{g}) output by the inverter 402 to the grid 404.

The power measurement stage 504 determines an active power (P) and a reactive power (Q) output from the inverter 402 based on the voltage (Vₛ) and current (I_{g}). The droop controller 502 may operate in two modes. In a first mode, the droop controller 502 determines the reference voltage (V_{ref}) and a reference frequency ( [symbol] _{ref}) for the inverter controller 100a based on the active power (P) and reactive power (Q) output by the power measurement stage 504. The droop controller 502 outputs, over first and second outputs, the reference voltage (V_{ref}) and a reference frequency (W_{ref}) to the inverter controller 100a. The reference voltage (V_{ref}) is used as an indirect input to the voltage controller 108 of the inverter controller 100a as described herein. The reference frequency (W_{ref}) controls the frequency of the output voltage of the inverter 402.

The PLL stage 506 receives, over a third input of the controller 502, a measurement of the grid voltage (V_{g}). The PLL stage 506 determines a frequency (W_{PLL}) and an amplitude (V_{PLL}) (or voltage level) of the grid voltage (V_{g}). The PLL stage 506 outputs the frequency (W_{PLL}) and the voltage level (V_{PLL}). In a second mode, the droop controller 502 determines the reference voltage (V_{ref}) and the reference frequency (W_{ref}) for the inverter controller 100a based on the amplitude (V_{PLL}) and frequency (W_{PLL}) provided by the PLL stage 506. For example, the droop controller 502 may set the reference voltage (V_{ref}) to be the same as the amplitude (V_{PLL}) provided by the PLL stage 506 and may set the reference frequency (W_{ref}) to be the same as the frequency (W_{PLL}) provided by the PLL stage 506

The droop controller 502 additionally determines the multiplication factor (K) and outputs the multiplication factor (K), over a third output, to the inverter controller 100a. As described herein, the multiplication factor (K) affects the impedance between the inverter and the grid, and the current output by the inverter. The droop controller 502 selects whether to operate in the first mode or the second mode to perform fault recovery as described herein. The droop controller 502 may also operate in a third mode during droop control as described herein.

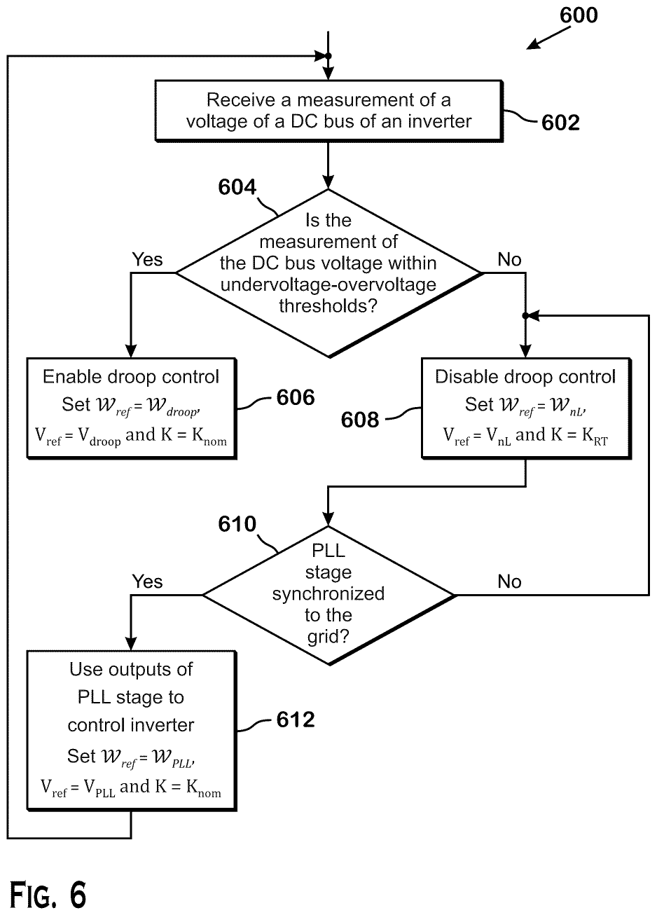

FIG. 6 shows a droop control method 600. The droop controller 502 may implement the method 600. In the method 600, the droop controller 502, at 602, receives a measurement of a voltage of a DC bus of the inverter 402. The DC bus may be a voltage line over which the inverter 402 receives DC voltage. The voltage of the bus may be measured by a voltage sensor, and the sensor may provide the voltage measurement to the droop controller 502.

Initially, the droop controller 502 may operate the inverter 402 in accordance with the first mode. The droop controller 502 may set the reference voltage (V_{ref}) to a no-load reference voltage (V_{nL}) and the reference frequency ( [symbol] _{ref}) to a no-load reference frequency ( [symbol] _{nL}). The droop controller 502 may determine the no-load reference voltage (V_{nL}) and the no-load reference frequency ( [symbol] _{nL}) based on the droop curve set points.

The droop controller 502 may be configured with an undervoltage threshold and an overvoltage threshold. At 604, the droop controller 502 may determine whether a measurement of the DC bus voltage is greater than the undervoltage threshold and less than the overvoltage threshold.

During a short circuit or overload condition, the difference between the phase (δ) of the inverter 402 and the phase (δ_{g}) of the grid 404 can dramatically increase. An increase in the difference causes power to circulate between the inverter 402 and the grid 404. When the difference is positive, the inverter 402 may export power that is above the rating of the inverter 402. The power export results in reducing the DC bus voltage. Conversely, when the difference is negative, the inverter 402 imports power from the grid causing the DC bus voltage to increase. The undervoltage threshold may be set to a DC voltage level at or below which the inverter 402 exports power that is in excess of the rating of the inverter 402. The overvoltage threshold may be set to a DC voltage level at or above which the inverter 402 imports power that is in excess of the rating of the inverter 402. For example, the undervoltage threshold may be 80% of a nominal DC bus voltage of the inverter and the overvoltage threshold may be 120% of the nominal DC bus voltage.

When the DC bus voltage is within the undervoltage-overvoltage thresholds, the droop controller 502 may utilize a droop control technique for operating the inverter 402. As described herein, droop control achieves synchronization by providing a negative feedback based on the circulating power between inverters and a grid. The fact that the DC bus voltage is within the undervoltage-overvoltage thresholds suggests the negative feedback exists and that droop control may effectively maintain synchronization. Conversely, when the DC bus voltage is greater than the undervoltage threshold or less than the overvoltage threshold, the droop controller 502 may implement a fault recovery technique as described herein to recover from the short circuit.

If the droop controller 502 makes a positive determination at 604, then the droop controller 502 enables droop control 606. When the droop controller 502 enables droop control 606, the droop controller 502 sets the reference frequency ( [symbol] _{ref}) of the inverter 402 to a droop control reference frequency (W_{droop}) provided by a droop control technique, sets the reference voltage (V_{ref}) to a droop control reference voltage (V_{droop}) provided by the droop control technique and sets the voltage multiplier (K) to a nominal voltage multiplier (Kₙₒₘ), which may be 1. For example, the nominal voltage multiplier (Kₙₒₘ) may be between 0.95 and 1.

If the droop controller 502 makes a negative determination at 604 and the droop controller 502 determines that the DC bus voltage is outside undervoltage-overvoltage thresholds, then the droop controller 502 disables droop control at 608. Instead of implementing droop control, the controller 502 aims to ride through the short circuit or overload condition by controlling the inverter to output current within its ratings. The droop controller 502 sets the reference voltage (V_{ref}) to the no-load reference voltage (V_{nL}) and the reference frequency (W_{ref}) to the no-load reference frequency (W_{nL}). The droop controller 502 may determine the no-load reference voltage (V_{nL}) and the no-load reference frequency (W_{nL}) based on the droop curve set points. The droop controller 502 sets the voltage multiplier (K) to a ride through voltage multiplier (K_{RT}). The ride through voltage multiplier (K_{RT}) controls the output current of the inverter. The output current is linearly related to the multiplication factor (K) (i.e., Iᵢₙᵥ ∝K) and is directly controlled by the multiplication factor (K). The droop controller 502 may set the ride through voltage multiplier (K_{RT}) to a value that retains the output current within a current rating of the inverter. Thus, with droop control disabled, the droop controller 502 ensures that the inverter operates within its rating limits.

The droop controller 502, at 610, determines whether the PLL stage 506 has synchronized to the grid. The PLL stage 506 synchronizes to the grid when it has locked on to the frequency and phase of the grid 404. For example, a quadrature component of the PLL stage 506 reflects a phasor error of the PLL stage 506. The droop controller 502 may evaluate the quadrature component and determine whether the quadrature component is within a specific (or acceptable) margin of error, such as 5%. If so, the droop controller 502 determines that the PLL stage 506 has synchronized to the grid 404. If not, the droop controller 502 determines that synchronism is not achieved. The PLL stage 506 may take some time to lock on to the frequency and phase of the grid 404, and the droop controller 502 continues disabling droop control and setting the reference voltage (V_{ref}) to the no-load reference voltage (V_{nL}), the reference frequency ( [symbol] _{ref}) to the no-load reference frequency (W_{nL}) and the voltage multiplier (K) to the ride through voltage multiplier (K_{RT}) so long as the PLL stage 506 has not synchronized. If a negative determination is made at 610, the droop controller 502 reverts to 608.

If a positive determination is made at 610 and the PLL stage 506 has synchronized, the droop controller 502 uses the outputs of the PLL stage 506 to control the inverter at 612. The droop controller 502 sets the reference voltage (V_{ref}) to the voltage level (V_{PLL}) output by the PLL stage, the reference frequency (W_{ref}) to the frequency (W_{PLL}) output by the PLL stage and the voltage multiplier (K) to the nominal voltage multiplier (Kₙₒₘ). Thus, the inverter will have the same the reference voltage (V_{ref}) and reference frequency (W_{ref}) as the grid. When the grid recovers, the method 600 reverts to 602, where the controller 502 evaluates whether the DC bus voltage is within undervoltage-overvoltage thresholds.

The inverter 402 may be one of multiple inverters (e.g., three inverters) that are coupled in parallel to each other and connected to the grid 404, which may be a three-phase grid. Each of the multiple inverters may feed current for a particular phase of the grid 404. The inverter 402 may synchronize with the grid 404 when one of the multiple inverters is synchronized with the grid 404. That is the case even when the remaining two phases lose synchronization and experience a short circuit or an overload condition. The inverter 402 may maintain synchronism when one of the multiple parallel-coupled inverters is synchronized to the grid 404 due to the fact that the one phase has power flow that ensures sufficient negative feedback for droop control to maintain synchronism.

Provided herein is a sync inverter that generates a fourth phase (or virtual phase). The fourth phase is synchronized with one of the three phases of the grid. The sync inverter may be coupled in parallel with remaining inverters in a three-phase system. The sync inverter may be communicatively coupled with the remaining inverters. The sync inverter may sense a grid voltage (three phase voltages) and synchronize with the grid voltage by using a simulated three-phase inverter model as described herein. The model may determine a power exported to the grid 404 and simulate an impedance between the sync inverter and the grid 404. The term ‘sync inverter’ is used herein to signify an inverter that generates a fourth phase and which may not output power to the grid. The term ‘grid inverter’ is used herein to signify an inverter that outputs power to the grid.

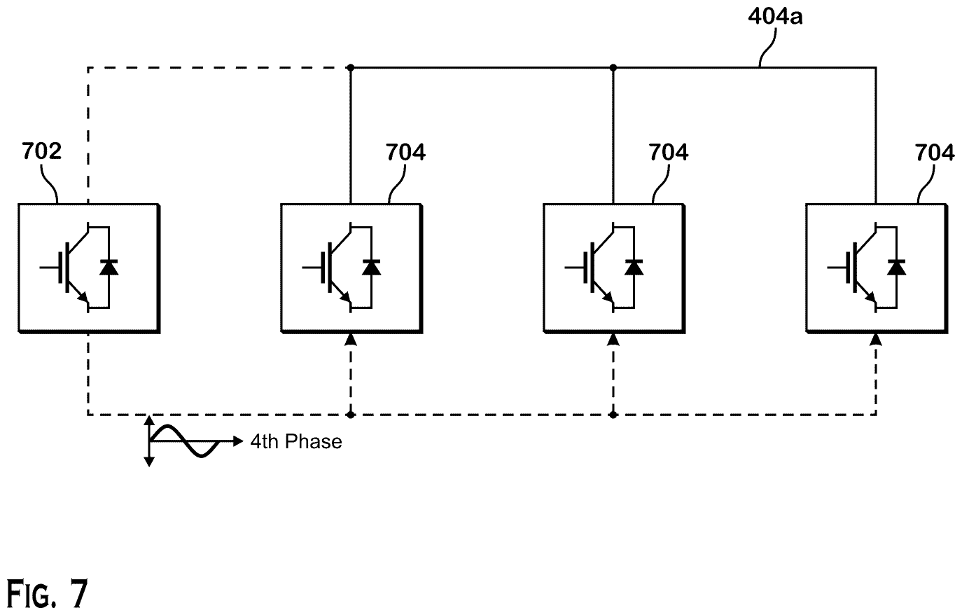

FIG. 7 shows a sync inverter 702 and a plurality of grid inverters 704 coupled to the grid 404a. The plurality of grid inverters 704 are coupled to each other in parallel. Each grid inverter 704 supplies power to the grid 404a. The grid inverters 704 may output power to an AC bus of the grid 404a. The sync inverter 702 generates a voltage in synchronization with the grid 404a (or AC bus thereof) and communicates the generated voltage either digitally or through electrical connections with the plurality of grid inverters 704 for maintaining synchronism with the grid 404a. For example, the sync inverter 702 may communicate with a droop controller or an inverter controller of each of the plurality of grid inverters 704.

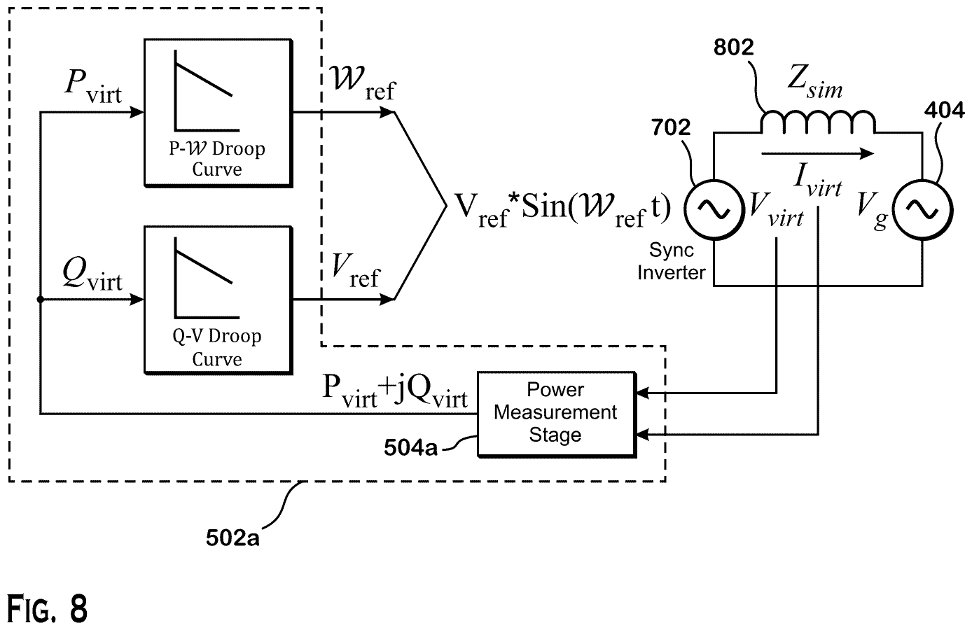

FIG. 8 shows a droop controller 502a of the sync inverter 702. The droop controller 502a includes a power measurement stage 504a. As described herein, a controller may control the sync inverter 702 to emulate an impedance (referred to herein as simulated impedance (Zₛᵢₘ) 802) between the sync inverter 702 and the grid 404. The power measurement stage 504a determines a measurement of a virtual current (Iᵥᵢᵣₜ) that would pass through the simulated impedance (Zₛᵢₘ) 802 during operation of the sync inverter 702. The power measurement stage 504a also determines a measurement of a virtual voltage (Vᵥᵢᵣₜ) that would be output by the sync inverter 702 during operation. The power measurement stage 504a determines a virtual active power (Pᵥᵢᵣₜ) and a virtual reactive power (Qᵥᵢᵣₜ) output by the sync inverter 702 based on the current and voltage measurements (Iᵥᵢᵣₜ, Vᵥᵢᵣₜ). The droop controller 502a uses an active power-frequency (P- [symbol] ) droop curve and the virtual active power (Pᵥᵢᵣₜ) to determine the reference frequency ( [symbol] _{ref}) for operating the sync inverter 702. The droop controller 502a uses a reactive power-voltage (Q−V) droop curve and the virtual reactive power (Qᵥᵢᵣₜ) to determine the reference voltage (V_{ref}) for operating the sync inverter 702. As described herein, the droop controller 502a may output the reference frequency ( [symbol] _{ref}) and the reference voltage (V_{ref}) to a controller of the sync inverter 702. The controller operates the sync inverter 702 at the reference voltage (V_{ref}) and reference frequency ( [symbol] _{ref}) and measures the virtual current (Iᵥᵢᵣₜ) and the voltage (Vᵥᵢᵣₜ) using the simulated impedance (Zₛᵢₘ) 802. The sync inverter 702 uses the reference voltage (V_{ref}) and reference frequency ( [symbol] _{ref}) to generate a fourth phase that is in synchronism with one of the three phases of the grid 404.

While FIG. 8 shows operation of the sync inverter 702 in isolation, the sync inverter 702 is coupled to the grid inverters 704 as described with reference to FIG. 7. The sync inverter 702 sends the fourth phase voltage either digitally through communication or electrically through electrical cables to the grid inverters 704 for use in controlling their respective output voltages and output currents.

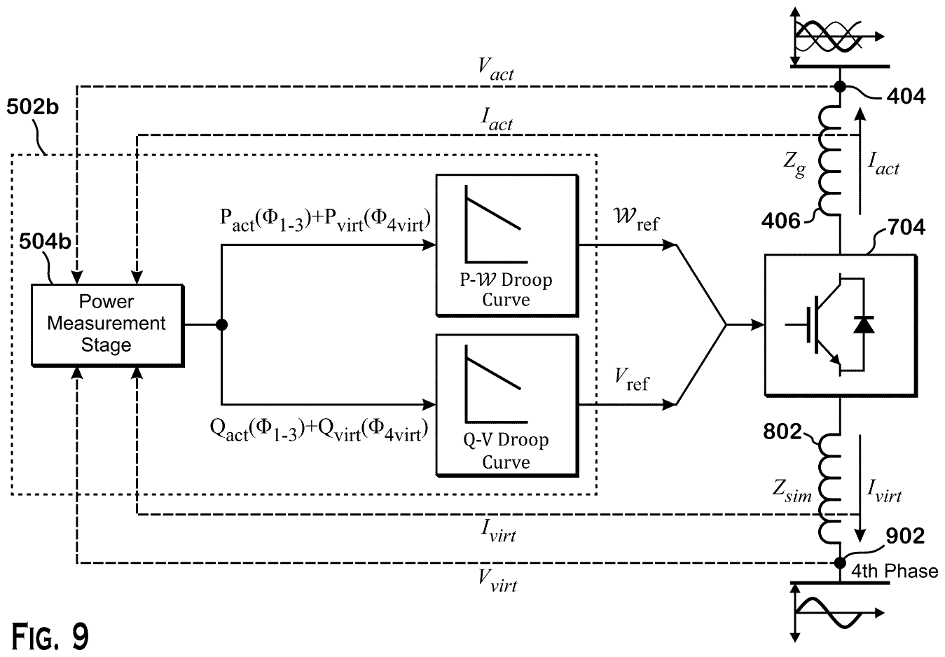

FIG. 9 shows a grid inverter 704 coupled to the grid 404. An impedance (Z_{g}) 406 is shown between the grid inverter 704 and the grid 404 through which a current (I_{act}) flows from the grid inverter 704 to the grid 404. Also shown is the simulated impedance (Zₛᵢₘ) 802 that the grid inverters 704 simulates between its output and the fourth phase 902 generated by the sync inverter 702 through which a current (Iᵥᵢᵣₜ) is simulated to flow. The grid inverter 704 has a droop controller 502b that utilizes an active power-frequency (P- [symbol] ) droop curve and a reactive power-voltage (Q−V) droop curve. The droop controller 502b includes a power measurement stage 504b as described herein.

The power measurement stage 504b receives both a measurement of the current (I_{act}) that flows from the grid inverter 704 to the grid 404 and the current (Iᵥᵢᵣₜ) that is simulated to flow through the impedance (Zₛᵢₘ) 802. As described herein, the impedance (Zₛᵢₘ) 802 is simulated by the grid inverter 704 between its output and the fourth phase 902 generated by the sync inverter 702. The power measurement stage 504b also receives both a measurement of the voltage (V_{act}) output by the grid inverter 704 to the grid 404 and the voltage (Vᵥᵢᵣₜ) that is generated by the sync inverter 702. The sync inverter 702 may determine the voltage (Vᵥᵢᵣₜ) and send the determined voltage to the grid inverter 704 using a communication protocol or through electrical cables.

For inverter control, the power measurement stage 504b determines the active and reactive powers output by the grid inverter 704 using both the voltages and currents. Because the current and voltage each have two components (a simulated component and an actual component), the power measurement stage 504b determines the active and reactive powers to each have two additive components; an actual component reflecting the current (I_{act}) and voltage (V_{act}) output by the grid inverter 704 and a virtual component reflecting the current (Iᵥᵢᵣₜ) and voltage (Vᵥᵢᵣₜ) that are simulated through the fourth phase 902 generated by the sync inverter 702. The power measurement stage 504b may add the actual component of the current (I_{act}) and the virtual component of the current (Iᵥᵢᵣₜ) to obtain a total current for power determination. The power measurement stage 504b may add the actual component of the voltage (V_{act}) and the virtual component of the voltage (Vᵥᵢᵣₜ) to obtain a total voltage for power determination.

The power measurement stage 504b determines the active power as P_{act}+Pᵥᵢᵣₜ, where P_{act} is the power output for the three phases (Φ₁₋₃) of the grid 404 and Pᵥᵢᵣₜ is the virtual power for a fourth virtual phase (Φ₄ᵥᵢᵣₜ) specified by the sync inverter 702. The power measurement stage 504b determines the reactive power as Q_{act}+Qᵥᵢᵣₜ, where Q_{act} is the power output for the three phases (Φ₁₋₃) of the grid 404 and Qᵥᵢᵣₜ is the virtual power for a fourth virtual phase (Φ₄ᵥᵢᵣₜ) specified by the sync inverter 702.

The droop controller 502b determines the reference voltage (V_{ref}) and the reference frequency ( [symbol] _{ref}) for operating the grid inverter 704 based on the active power (P_{act}+Pᵥᵢᵣₜ) and the reactive power (Q_{act}+Qᵥᵢᵣₜ). The active power and the reactive power each have components of the of the virtual phase (or fourth phase 902) generated by the sync inverter 702. The sync inverter 702 is controlled to synchronize to a phase of the grid voltage and simulate an impedance at its output. Thus, by incorporating the virtual power components simulated in the fourth phase 902, the droop controller 502b of the grid inverter 704 is operated with a reference voltage and a reference frequency that result in implementing the simulated impedance and synching to the phase of the grid voltage.

It is noted that the sync inverter 702 may not export power to the grid 404 and its rating may be minimal. However, sync inverter 702 virtually operates in a similar manner as the grid inverter 704 and performs droop control. The sync inverter 702 may be implemented digitally where the fourth phase 902 can be relayed to the grid inverters 704 through digital communication. Instead of sensing the fourth phase generated by the sync inverter, the grid inverters reconstruct the fourth phase using samples communicated by the sync inverter digitally and use it as an effective fourth phase voltage measurement. This avoids the need for physical inverter hardware for the sync inverter.

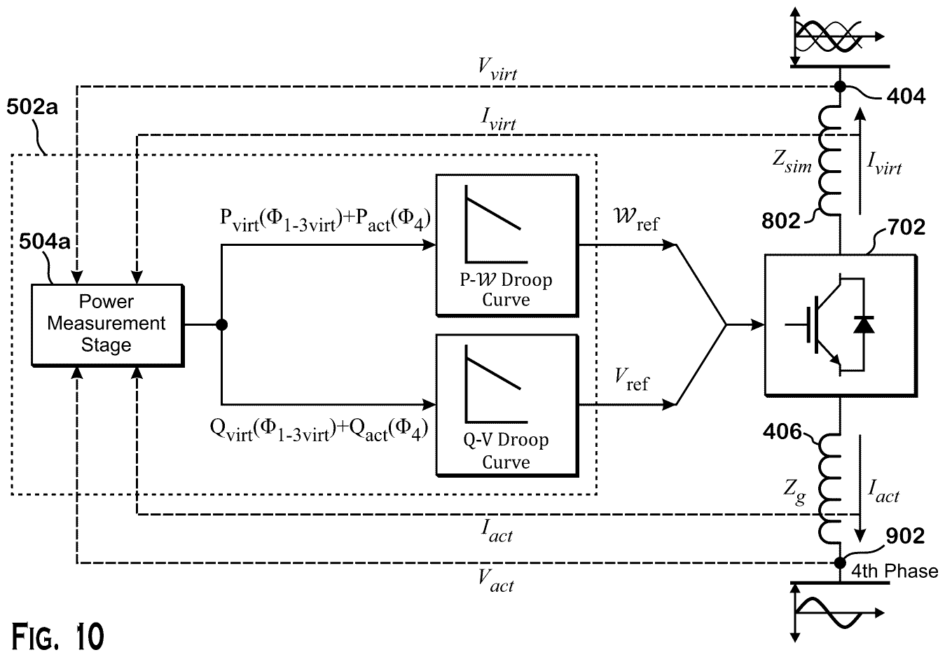

FIG. 10 shows a sync inverter 702 coupled to the grid 404. The sync inverter 702 has the simulated impedance (Zₛᵢₘ) 802 that the sync inverter 702 emulates at its output to grid 404. The impedance (Za) 406 is the output impedance of the sync inverter 702 on its fourth phase 902. As the fourth phase 902 is physically connected to the inverters on the grid 404, an actual current (I_{act}) flows through it. Alternatively, when the fourth phase voltage is communicated to the grid inverters 704 digitally, the impedance (Za) 406 can be a simulated impedance and the current (I_{act}) can be simulated by the grid inverters 704 and relayed to the sync inverter 702 through communication. From the perspective of the sync inverter 702, a virtual current (Iᵥᵢᵣₜ) is simulated to flow through the simulated impedance (Zₛᵢₘ) 802 that connects the sync inverter 702 to the grid 404. It is noted that from the perspective of the sync inverter 702, the current (Iᵥᵢᵣₜ) flowing through the impedance (Zₛᵢₘ) 406 is a virtual current, rather than an actual current.

As described herein, the sync inverter 702 has a droop controller 502a that utilizes an active power-frequency (P−W) droop curve and a reactive power-voltage (Q−V) droop curve. The droop controller 502a also includes a power measurement stage 504a as described herein.

The power measurement stage 504a receives both a measurement of the current (Iᵥᵢᵣₜ) that is simulated between the output of the sync inverter 702 and the grid 404 and the current (I_{act}) that flows through the virtual fourth phase generated by the sync inverter 702. The power measurement stage 504a also receives both a measurement of the voltage (Vᵥᵢᵣₜ) output by the grid inverters 704 and the fourth phase voltage (V_{act}) that is generated or simulated to be output by the sync inverter 702. The measurement of the voltage (Vᵥᵢᵣₜ) may be made by a voltage sensor coupled to the grid. The sync inverter 702 may determine the fourth phase voltage (V_{act}).

The power measurement stage 504a determines the active and reactive powers output by the sync inverter 702 using both the voltages and currents. The power measurement stage 504b determines the active and reactive powers as having two components; an actual component reflecting the current (I_{act}) and voltage (V_{act}) determined by the sync inverter 702 and a virtual component reflecting the current (Iᵥᵢᵣₜ) and voltage (Vᵥᵢᵣₜ) through the simulated impedance (Zₛᵢₘ).

The power measurement stage 504a determines the active power as P_{act}+Pᵥᵢᵣₜ. P_{act} is the active power determined output for the fourth phase (4) and Pᵥᵢᵣₜ is the simulated active power output to the three phases (Φ₁₋₃ᵥᵢᵣₜ) of the grid. The power measurement stage 504b determines the reactive power as Q_{act}+Qᵥᵢᵣₜ, where Q_{act} is the reactive for the fourth phase (4) specified by the sync inverter 702 and Qᵥᵢᵣₜ is the simulated reactive power output to the three phases (Φ₁₋₃ᵥᵢᵣₜ) of the grid 404.

The droop controller 502a determines the reference voltage (V_{ref}) and the reference frequency ( [symbol] _{ref}) for operating the sync inverter 702 based on the active power (P_{act}+Pᵥᵢᵣₜ) and the reactive power (Q_{act}+Qᵥᵢᵣₜ). As described herein, the active power and the reactive power each have components of the virtual phase (or fourth phase) generated by the sync inverter 702.

The sync inverter 702 measures the power export to the grid 404 by simulating an impedance (Zₛᵢₘ) and calculating the current through the impedance (Zₛᵢₘ). The sync inverter 702 adds the fourth phase to the measured power to generate the frequency and voltage references through droop curve control. A grid inverter 704 measures the power export to the grid 404 and the virtual power of the fourth phase to generate its frequency and voltage references.

The apparent power of the sync inverter 702 is the sum of the apparent power of the three phases (S(Φ₁₋₃ᵥᵢᵣₜ)) and the apparent power of the fourth phase (S(+4)). That is, S_{sync Inv}=S(Φ₁₋₃ᵥᵢᵣₜ)+S(Φ₄). The apparent power of a grid inverter 704 is the sum of the apparent power of the three phases (S(Φ₁₋₃)) and the apparent power of the fourth phase (S(Φ₄ᵥᵢᵣₜ)). That is, S_{Grid Inv}=S(Φ₁₋₃)+S(Φ₄ᵥᵢᵣₜ).

During normal operating conditions, droop control achieves synchronism between the grid inverters 704 and the grid 404 and maintains power sharing between the grid inverters 704. During normal operating conditions, there is minimal load on the fourth phase. The apparent power of the fourth phase approximates to zero power (i.e., S(Φ₄ᵥᵢᵣₜ)=S(Φ₄)≈0). Thus, the power output of the grid inverters 702 and the sync inverter 702 is concentrated in the three phase of the grid 404. That is, S_{sync Inv}=S(Φ₁₋₃ᵥᵢᵣₜ)=S_{Grid Inv}=S(Φ₁₋₃).

During three-phase short circuit conditions, the grid voltage (V_{act}) that is detected by a grid inverter 704 and the grid voltage (Vᵥᵢᵣₜ) that is detected by the sync inverter 702 collapse to near zero volts. Consequently, the power component attributable to the three phases of the grid 404 also becomes approximately zero. That is, S(Φ₁₋₃ᵥᵢᵣₜ)=S(Φ₁₋₃)=0. However, due to the fourth phase, a drift in the frequencies of the grid inverters 704 results in a circulating power being measured by the sync inverter 702 using the fourth phase. Consequently, the sync inverter 702 provides negative feedback that keeps the frequency of the grid inverters 704 at a no-load frequency. The fourth phase achieved through virtual droop control of the sync inverter keeps the frequency of the grid inverters 704 at a no-load frequency during short circuit conditions and mitigates phase shifts, thereby aiding in performing safe short circuit recovery.

As described herein, a controller may include a data processing system, such as an Application Specific Integrated Circuit (ASIC), Field-Programmable Gate Array (FPGA), electronic circuit, central processing unit (CPU), arithmetic and logic unit (ALU) or a combination thereof. The controller may include non-transitory memory, which may be read-only, programmable read-only, random access or a hard. The non-transitory memory stores machine-readable instructions that when executed by the controller cause the controller to perform the techniques described herein. The machine-readable instructions may be one or more software or firmware programs or routines. The controller may include combinational logic circuits, input circuits (inputs), output circuits (outputs), signal conditioning circuits, buffers and other components, which may be accessed by and executed by the data processing system to perform the techniques described herein. The input and output circuits may include analog/digital converters and related devices that monitor inputs from sensors. Software, firmware, programs, instructions, control routines, code, algorithms and similar terms mean controller-executable instruction sets including calibrations and look-up tables. A controller may communicate using a direct wired point-to-point link, a networked communication bus link, a wireless link or any other type of communication technology. Communication includes exchanging data signals, including, for example, electrical signals via a conductive medium; electromagnetic signals via air; optical signals via optical waveguides; etc. The data signals may include discrete, analog and/or digitized analog signals representing inputs from sensors and communication between controllers. It is noted that although various functionality is described herein as being performed by different controllers or other devices (such as, adders and subtractors), one controller may perform functionality of multiple controllers.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A system, comprising:
a sync inverter; and
a grid inverter,
wherein the sync inverter is configured to:
synchronize to a phase of a grid voltage and generate a virtual fourth phase that is synchronized to the phase of the grid voltage; and
output a voltage of the virtual fourth phase, and
wherein the grid inverter includes a controller that is configured to:
receive the voltage of the virtual fourth phase from the sync inverter;
simulate an impedance between an output of the grid inverter and the voltage of the virtual fourth phase;
determine active power and reactive power components for the virtual fourth phase; and
determine, using droop control, a reference voltage and a reference frequency for operating the grid inverter based on the active power and reactive power components for the virtual fourth phase.

2. The system of claim 1, wherein the controller includes:
a first input configured to receive a measurement of the grid voltage;
a first output configured to output the reference voltage;
a second output configured to output the reference frequency;
a third output configured to output a multiplication factor; and
a phase lock loop (PLL) stage configured to:
synchronize to the grid voltage,
wherein the controller is configured to:
determine whether a voltage of a DC bus of the grid inverter is less than an undervoltage threshold or greater than an overvoltage threshold;
in response to determining that the voltage of the DC bus is less than the undervoltage threshold or greater than the overvoltage threshold,
disable droop control;
during a time when the PLL stage is not synchronized to the grid voltage, set the multiplication factor to a ride through voltage multiplier; and
after the PLL stage synchronizes to the grid voltage, set the multiplication factor to a nominal multiplier different from the ride through voltage multiplier, set the reference voltage to a reference voltage output by the PLL stage and set the reference frequency to a reference frequency output by the PLL stage.

3. The system of claim 2, wherein the controller includes:
a second input configured to receive a measurement of an output current of the grid inverter; and
a third input configured to receive a measurement of an output voltage of the grid inverter,
wherein the controller is configured to:
in response to determining that the voltage of the DC bus is greater than the undervoltage threshold and less than the overvoltage threshold,
enable the droop control; and
set the multiplication factor to the nominal multiplier, set the reference voltage and the reference frequency to a reference voltage and a reference frequency, respectively, that are both determined based on the output current and the output voltage of the inverter.

4. The system of claim 3, wherein:
the controller is communicatively coupled to the sync inverter, and
the controller is configured to, when the droop control is enabled:
sum a virtual output current of the virtual fourth phase and the output current of the inverter to determine a total current;
sum a virtual output voltage of the virtual fourth phase and the output voltage of the inverter to determine a total voltage; and
set the reference voltage and the reference frequency to the reference voltage and the reference frequency, respectively, that are both determined based on the total current and the total voltage.

5. The system of claim 4, wherein the virtual output voltage and the virtual output current cause the impedance to be presented at a power output of the grid inverter and mitigate a phase shift between the grid inverter and a grid.

6. The system of claim 2, wherein the ride through voltage multiplier is a multiplier that causes the output current of the inverter to be within output current ratings of the inverter.

7. The system of claim 2, wherein the PLL stage is configured to lock to a frequency of a grid and output the frequency of the grid and the voltage of the grid.

8. The system of claim 2, wherein the nominal multiplier is between 0.95 and 1.

9. The system of claim 2, wherein the controller is configured to set the multiplication factor to a value that simulates the impedance between the output of the grid inverter and the voltage of the virtual fourth phase.

10. The system of claim 1, wherein the controller includes an inner current control loop and an outer voltage control loop.

11. A method, comprising:
synchronizing, by a sync inverter, to a phase of a grid voltage and generating a virtual fourth phase that is synchronized to the phase of the grid voltage;
outputting, by the sync inverter, a voltage of the virtual fourth phase;
receiving, by a controller of a grid inverter, the voltage of the virtual fourth phase from the sync inverter;
simulating, by the controller of the grid inverter, an impedance between an output of the grid inverter and the voltage of the virtual fourth phase;
determining, by the controller of the grid inverter, active power and reactive power components for the virtual fourth phase; and
determining, by the controller of the grid inverter using droop control, a reference voltage and a reference frequency for operating the grid inverter based on the active power and reactive power components for the virtual fourth phase.

12. The method of claim 11,
wherein the controller includes:
a first input configured to receive a measurement of the grid voltage;
a first output configured to output the reference voltage;
a second output configured to output the reference frequency; and
a third output configured to output a multiplication factor, and
wherein the method comprises:
synchronizing, by a phase lock loop (PLL) stage of the controller, to the grid voltage;
determining, by the controller, whether a voltage of a DC bus of the grid inverter is less than an undervoltage threshold or greater than an overvoltage threshold;
in response to determining that the voltage of the DC bus is less than the undervoltage threshold or greater than the overvoltage threshold,
disabling droop control;
during a time when the PLL stage is not synchronized to the grid voltage, setting the multiplication factor to a ride through voltage multiplier; and
after the PLL stage synchronizes to the grid voltage, setting the multiplication factor to a nominal multiplier different from the ride through voltage multiplier, setting the reference voltage to a reference voltage output by the PLL stage and setting the reference frequency to a reference frequency output by the PLL stage.

13. The method of claim 12, wherein:
the controller includes:
a second input configured to receive a measurement of an output current of the grid inverter; and
a third input configured to receive a measurement of an output voltage of the grid inverter, and
the method comprises:
in response to determining that the voltage of the DC bus is greater than the undervoltage threshold and less than the overvoltage threshold,
enabling the droop control; and
setting the multiplication factor to the nominal multiplier, setting the reference voltage and the reference frequency to a reference voltage and a reference frequency, respectively, that are both determined based on the output current and the output voltage of the inverter.

14. The method of claim 13, wherein:
the controller is communicatively coupled to the sync inverter, and
the method comprises:
when the droop control is enabled:
summing, by the controller, a virtual output current of the virtual fourth phase and the output current of the inverter to determine a total current;
summing, by the controller, a virtual output voltage of the virtual fourth phase and the output voltage of the inverter to determine a total voltage; and
setting, by the controller, the reference voltage and the reference frequency to the reference voltage and the reference frequency, respectively, that are both determined based on the total current and the total voltage.

15. The method of claim 14, wherein the virtual output voltage and the virtual output current cause the impedance to be presented at a power output of the grid inverter and mitigate a phase shift between the grid inverter and a grid.

16. The method of claim 12, wherein the ride through voltage multiplier is a multiplier that causes the output current of the inverter to be within output current ratings of the inverter.

17. The method of claim 12, wherein the PLL stage is configured to lock to a frequency of a grid and output the frequency of the grid and the voltage of the grid.

18. The method of claim 12, wherein the nominal multiplier is between 0.95 and 1.

19. The method of claim 12, wherein the controller is configured to set the multiplication factor to a value that simulates the impedance between the output of the grid inverter and the voltage of the virtual fourth phase.

20. The method of claim 11, wherein the controller includes an inner current control loop and an outer voltage control loop.
